(19) United States
(12) Patent Application Publication
(10) Pub. No.: US 2009/0291283 A1
(43) Pub. Date: Nov. 26, 2009

(54) FLUOROPOLYMER FILMS

(75) Inventors: Roman B. Larichev, Wilmington, DE (US); Andrew Edward Feiring, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. duPont de Nemours and Company, Wilmington, DE (US)

(21) Appl. No.: 12/124,488

(22) Filed: May 21, 2008

(51) Int. Cl. B32B 27/32; C08F 214/18

(52) U.S. Cl. 428/220; 526/253

(57) ABSTRACT

Provided are free standing films of copolymers of 1,2,3,3,3-pentafluoropropylene and tetrafluoroethylene, and processes for preparing the films.

### FIELD OF THE INVENTION

The present invention is directed to free standing films of copolymers of 1,2,3,3,3-pentafluoropropylene and tetrafluoroethylene, and processes for preparing the films.

### BACKGROUND OF THE INVENTION

Sianesi et al., U.S. Pat. No. 3,350,373 discloses copolymers of 1,2,3,3,3-pentafluoropropylene and tetrafluoroethylene, a method for preparing them, and a process for melt forming shaped articles. Sianesi's polymers are crystalline polymers having 1,2,3,3,3-pentafluoropropylene comonomer concentrations of less than 20 mol-%.

Hrivnak et al., U.S. Pat. No. 6,248,823, discloses solvents for so-called amorphous fluoropolymers. Amorphous fluoropolymers include copolymers of TFE with perfluoromethylvinylether, perfluoroethylvinylether, perfluoropropylene (HFP), perfluorodimethyldioxole, perfluoro-2-(2-fluorosulfonylethoxy)propyl vinyl ether, and others. Solvents disclosed include fluorinated alkanes, fluorinated alkenes, fluorinated sulfides, hexafluorobenzene and others. Amorphous fluoropolymers are characterized by having no melting transition with a heat of fusion greater than 1 J/g as determined by differential scanning calorimetry (DSC). The HFP copolymers are ca. 48 mole percentHFP.

### SUMMARY OF THE INVENTION

One aspect of the present invention is a film comprising an amorphous copolymer comprising 50 to 80 mole percent of monomer units derived from tetrafluoroethylene and 20 to 50 mole percent of monomer units derived from 1,2,3,3,3-pentafluoropropylene.

Another aspect of the present invention is a process for forming a film, the process comprising heating an amorphous copolymer comprising 50 to 80 mole percent of monomer units derived from tetrafluoroethylene and 20 to 50 mole percent of monomer units derived from 1,2,3,3,3-pentafluoropropylene to a temperature between 120° C. and 150° C., and subjecting the thus heated copolymer to pressure and shear to form a film.

### BRIEF DESCRIPTION OF FIGURES

FIGS. 1-3 show the differential scanning calorimetry scans for polymers prepared in the Examples.

### DETAILED DESCRIPTION

As used herein, the term “film” refers to a planar shaped article comprising two planar dimensions and a third thickness dimension wherein the planar dimensions exceed the thickness dimension by at least a factor of 10, preferably a factor of 100, and the thickness dimension ranges from 10 to 250 micrometers, preferably 25 to 100 micrometers.

As used herein, the term “amorphous” refers to a polymer having no melting endotherm characterized by a heat of fusion greater than 1 J/g as determined by differential scanning calorimetry (DSC). Amorphous copolymers of TFE with 1,2,3,3,3-pentafluoropropylene have not previously been reported.

As used herein the term “copolymer” shall be understood to refer to a polymer comprising 20 to 50 mole percent of 1,2,3,3,3-pentafluoropropylene and 50 to 80 mole percent of TFE. The term further encompasses terpolymers or other multi-polymers wherein an additional one or more monomer units derived from olefinic monomers are included in the copolymer. However, in such case, the total of all the one or more additional monomer units shall not exceed 10 mol-%.

When a copolymer suitable for the film is described herein as “comprising 20-50 mole percent of 1,2,3,3,3-pentafluoropropylene”, this means that the copolymer comprises 20 to 50 mole percent of monomer units derived from 1,2,3,3,3-pentafluoropropylene upon polymerization with TFE. Similarly, when the copolymer is described as “comprising 50 to 80 mole percent of TFE,” this means that the copolymer comprises 50 to 80 mole percent of monomer units derived from TFE upon polymerization with 1,2,3,3,3-pentafluoropropylene. Similar descriptions are used herein in the same manner.

The films disclosed herein are characterized by novel solubility characteristics that afford a high and unusual utility. Tetrafluoroethylene homopolymers are well-known to be virtually insoluble and intractable, partially because of high crystallinity and partially because of high molecular weight. Fluorinated copolymers of tetrafluoroethylene and other olefinic fluoromonomers such as hexafluoropropylene and perfluoropropylvinyl ether are insoluble at comonomer (i.e., non TFE) content below about 20 mol-%.

Hrivnak et al. disclose that at comonomer content of around 25 mole percent up to ca. 50 mole percent the copolymers known in the art become substantially amorphous, and exhibit moderate to good solubility in a wide range of fluorinated solvents, as well as some other solvents such as hydrocarbons and supercritical CO₂.

The present inventors have found that, surprisingly, solubility of the films disclosed herein is limited to highly fluorinated aromatic hydrocarbon solvents. Solubility in other fluorinated solvents is not observed. A certain amount of swelling is sometimes observed, but a liquid solution is not formed. The films are characterized by the absence of any melting endotherm having a heat of fusion greater than 2 J/g as determined by differential scanning calorimetry (DSC).

The novel solubility behavior of the films gives rise to high utility because the films are substantially inert even to most fluorinated solvents. Thus, for example, a film can be laminated to an electronic component as a protective layer or pellicle. Semi-conductor manufacturing involves the use of fluorinated solvents for cleaning and other purposes. The film can protect an encapsulated component from attack by fluorinated solvents without significant degradation of the film itself.

For example, a multi-layer polymeric laminate comprising one layer of a film as disclosed herein can be fabricated by depositing a solution of a different polymer, preferably a different fluoropolymer, onto the surface of the film to form a two-layer structure, or applied on both sides of the film to form a three-layer structure comprising the film . The film can also be laminated to other thermoplastic films using heat and pressure as is common in the art of thermoplastic films.

Accordingly, the present invention provides, in one embodiment, a film comprising an amorphous copolymer comprising 50 to 80 mole percent of monomer units derived from tetrafluoroethylene and 20 to 50 mole percent of monomer units derived from 1,2,3,3,3-pentafluoropropylene. Preferably the copolymer comprises 25 to 50 mole percent of monomer units derived from 1,2,3,3,3-pentafluoropropylene. More preferably the copolymer comprises 30 to 45 mole percent of monomer units derived from 1,2,3,3,3-pentafluoropropylene.

The copolymers used in making the films can be prepared according to methods known in the art. The composition of the copolymer can be varied by varying the composition of the monomeric mixture and the temperature at which the polymerization reaction is conducted. Generally, higher reaction temperatures favor incorporation of a higher proportion of 1,2,3,3,3-pentafluoropropylene units into the copolymer.

It is known that 1,2,3,3,3-pentafluoropropylene is less reactive in copolymerization than TFE under some conditions. In order to achieve the desirably high 1,2,3,3,3-pentafluoropropylene incorporation into the copolymer, the polymerization mixture preferably has a higher content of the 1,2,3,3,3-pentafluoropropylene than that which is desired in the final product. Thus, the monomer concentration of 1,2,3,3,3-pentafluoropropylene preferably ranges from about 50 mole percent to about 85 mole percent and the concentration of TFE ranges from about 15 mole percent to about 50 mole percent

The fluorinated copolymers suitable for use in making the films can be prepared at temperatures ranging from about −30° C. to about 200° C., under pressures varying from atmospheric to above 300 atmospheres, and in the presence of free-radical polymerization initiators. The preferred reaction temperature and pressure depend on the type of catalysis used. The polymerization can be carried out in an aqueous medium if desired, including an aqueous suspension, aqueous emulsion, polymerization in bulk or in solution.

When polymerization is carried out in non-aqueous solution, inert solvents that do not contain C—H bonds are preferred. Suitable inert solvents include perhalogenated or perfluorinated compounds that are liquid under operating conditions, such as perfluorocyclobutane, perfluorodimethylcyclobutane, perfluoropropylpyrane, or tetrafluorodichloroethane. Suitable initiators include perhalogenated or peffluorinated peroxy compounds such as peroxides of trichloroacetic acid, heptafluorobutyric acid, trifluoroacetic acid, pentafluoropropionic acid, or perfluorocaprylic acid. In addition, peroxides of the ω-hydroperfluoro acids having the general formula H(CF₂)ₙ—COOH wherein n ranges from 1 to 8 can be used.

In aqueous polymerization, suitable initiators include water-soluble organic peroxides, diperoxides or hydroperoxides, or inorganic peroxides. Suitable inorganic peroxides include ammonium or alkaline and alkaline earth metals persulphates, perphosphates, perborates, barium peroxide, sodium peroxide, or hydrogen peroxide. Suitable organic peroxides includebenzoyl peroxide, p. chlorobenzoyl peroxide, 2,4-dicblorobenzoyl peroxide, acetyl peroxide, trichloroacetyl. peroxide, lauroyl peroxide, succinyl peroxide, di-t.-butyl peroxide, peroxides and bydroperoxides of methylethylketone and of cyclohexanone, t-butyl perbenzoate, t-butyl-hydroperoxide, or cumyl hydroperoxide. Aliphatic azo-compounds can also be employed, such as alpha, alpha′azobis(isobutyronitrile), alpha, alpha′-azobis(alpha-methyl-gamma-carboxybutyronitrile), alpha, alpha′-azobis(alpha, gamma-dimethyl-gamma-carboxy-valeronitrile), alpha, alpha′-azobis(alpha-propyl-gamma-carboxybutyronitrile).

Other ingredients that can be used in aqueous polymerization include emulsifying agents, activators, accelerators, modifiers, buffers, etc. Emulsifying agents include alkali, alkaline earth or ammonium salts of perhalogenated or ω-hydroperhalogenated fatty acids having 6 to 20 carbons atoms. Suitable activators include sodium bisulphite, metabisulphite and thiosulphate or, in general, any water-soluble reducing substance. The accelerators include salts of metals occuring in various valence states, such as soluble salts of iron, copper, silver, etc. The modifiers include mercaptans or the aliphatic halocarbons which may be employed to regulate the polymerization reaction. Suitable buffering agents include sodium or potassium mono-or bi-phosphates or mixtures thereof, sodium metaborate, or borax.

When the copolymerization reaction is carried out in water, it is preferred to operate at a temperature ranging from about 5° C. to 100° C. and more preferably at a temperature ranging from about 10° C. to 90° C. under a pressure ranging from atmospheric to 200 atm.

The copolymer is then subject to drying. Drying at 50° C. in a vacuum oven overnight is satisfactory. However, other methods of drying such as are known in the art are also suitable. The dried copolymer typically forms a powder.

In one method for forming a film, an aliquot of the powder is placed between the platens of a heated hydraulic press and subjected to heat and pressure to form a film. The film can then simply be peeled off a convenient substrate such as Kapton® Polyimide Film (available from DuPont).

In an alternative method for forming a film the powder is fed to a melt extruder such as is well known and widely used in the plastics industry, subject to heating as it is transported along a screw and in molten form fed under pressure to a die having a horizontal slit opening to form the molten polymer into a film as the polymer is extruded from the die. The resulting film is then contacted with a quenching surface such as a polished drum and rolled up. Alternatively the film can be melt cast onto a continuously moving substrate.

The films are preferably clear, homogeneous, ductile and tough. Desirably, they can be readily curved or bent and are not rigid but limp and flexible. However they preferably have sufficient mechanical integrity that they can be free-standing—that is, separated from any substrate.

### EXAMPLES

### Example 1

5 g of a 20% solution of ammonium perfluorooctanoate was diluted to 100 mL with deionized water and combined with 0.20 g of ammonium persulfate (Sigma-Aldrich) (0.20 g) in a Hastelloy® C 400 cm³ autoclave. The autoclave was chilled to 5° C., evacuated, pressured with nitrogen to 400 psi and vented off. The pressuring and venting were repeated and a vacuum was then applied to the interior of the autoclave. The autoclave was then chilled to −30° C. 56 g of 1,2,3,3,3-pentafluoropropylene prepared in the manner described by Sianesi et al., op.cit. was condensed in followed by pressuring with 14 g of TFE) and sealing. The sealed autoclave was heated to 70° C. and held for 16 hours. During that time the pressure gradually decreased from 377 psi to 321 psi. The autoclave was cooled to room temperature, and the excess gases were vented off. A clear aqueous solution was removed from the reactor and frozen in dry ice for at least 4 hours. The frozen solution was then allowed to thaw and then filtered through #1 Whatman filter paper. The white residue was suspended in 500 ml of deionized water, stirred for 30 minutes, filtered again, and dried on the filter by pulling air through. The resulting polymeric residue was further dried in vacuum oven at 50° C. for 12 hours. 14.8 g of white spongy polymer was obtained after drying. The ¹⁹F NMR of the melted polymer (at 160° C.) showed four broad peaks which upon integration showed that the polymer contained 27 mole percent of 1,2,3,3,3-pentafluoropropylene.

180 mg of the thus prepared polymer was dissolved in 3.3 g of hexafluorobenzene (Aldrich) by stirring at room temperature for 30 minutes to give a clear, homogeneous 5 wt.-% solution. The thus prepared solution was cast on a regular glass plate using a 0.005 in. (127.5 micrometer) Doctor's blade. After evaporation of the solvent a coating 1-2 micrometers thick remained on the glass plate.

Attempts to prepare similar solutions using other solvents were unsuccessful. The mixtures made were neither clear nor homogeneous. Solvents employed were dichloromethane (OmniSolve), toluene (OmniSolv), acetone (EMD), Vertrel XF (2,3-dihydrodecafluoropentane—DuPont), Novec HFE 7500 (3-ethoxy-1,1,1,2,3,4,4,5,5,6,6,6-dodecafluoro-2-trifluoromethyl-hexane—Synquest).

0.5 g of polymer powder was placed between sheets of Kapton® Polyimide Film to form a sandwich. The sandwich so formed was placed between the platens of a hydraulic press (Pasadena Hydraulics) and held at contact pressure for 5 minutes at 120° C. After the 5 minute pre-heat, the force on the press was increased to 15,000 lbs. and held for 3 minutes. Then the press was cooled to 60° C. and the pressure was released. A film approximately 75 micrometers in thickness) was obtained. A second specimen was prepared under identical conditions except that the temperature was 135° C. and the resulting film was approximately 65 micrometers thick. In both cases, the films were clear, homogeneous, ductile and tough.

### Example 2

The procedures of Example 1 were repeated except that 56 g of 1,2,3,3,3-pentafluoropropylene and 9 g of TFE were used. During the polymerization the pressure decreased from 336 psi to 318 psi. 5.6 g of dry polymer were obtained. The ¹⁹F NMR of the melted polymer (at 115° C.) showed four broad peaks which upon integration showed that the polymer contained 36.5 mole percent of 1,2,3,3,3-pentafluoropropylene.

500 mg of the thus prepared polymer was dissolved in 3.3 g of hexafluorobenzene by stirring at room temperature for 30 minutes to give a clear, homogeneous 13 wt-% solution.

Attempts to prepare similar solutions using other solvents resulted in mixtures that were neither clear nor homogeneous. Solvents employed were dichloromethane (OmniSolve), toluene (OmniSolv), acetone (EMD), Vertrel XF (2,3-dihydrodecafluoropentane—DuPont), Novec HFE 7500 (3-ethoxy-1,1,1,2,3,4,4,5,5,6,6,6-dodecafluoro-2-trifluoromethyl-hexane—Synquest). The Vertrel XF and Novec HFE solvents made the polymer look like an oil, which stuck to the glass walls of the vessel, but did not form a solution.

### Example 3

The procedures of Example 1 were repeated except that 46 g of 1,2,3,3,3-pentafluoropropylene and 31 g of TFE were used and the autoclave was heated to 80° C. for ten hours. During the polymerization the pressure decreased from 530 psi to 367 psi. 29.3 g of dry polymer were obtained. The ¹⁹F NMR of the melted polymer (at 115° C.) showed four broad peaks which upon integration showed that the polymer contained 20 mole percent of 1,2,3,3,3-pentafluoropropylene.

The polymer did not dissolve in hexafluorobenzene at room temperature to any significant extent, but at 60° C. 200 mg dissolved fairly easily in 2 mL of hexafluorobenzene to give a clear solution. Upon cooling the solution down to room temperature it became a gel.

### Comparative Example A and Examples 4 and 5

In order to identify a melting endotherm and determine the heat of fusion, the following procedure was followed. A 7-10 mg of specimen was crimped in a standard sealed aluminum DSC pan. The specimen was placed in a TA Instruments model Q2000 DSC and heated rapidly (ca. 20 C°/min) to a temperature in the range of 260-320° C. and held at temperature for 3 minutes followed by cooling to ca. 0° C. The specimen was then reheated to the maximum temperature of 260-320° C. at 10° C./min rate with the aid of a mechanical cooler for temperature control, and data was recorded. The location of the melting endotherm, where one existed, was determined visually, and the heat of fusion determined from the weight normalized integral of the melting endotherm.

### Comparative Example A

The procedures of Example 1 were repeated except that 49 g of 1,2,3,3,3-pentafluoropropylene and 26 g of TFE were used and the autoclave was heated to 80° C. for ten hours. During the polymerization the pressure decreased from 465 psi to 445 psi. 8.6 g of dry polymer were obtained. A DSC curve obtained between ca. 0° C. and 300° C. exhibited a broad shallow endotherm with a heat of fusion of ca. 6 J/g indicating a small amount of crystallinity. The ¹⁹F NMR of the melted polymer (at 115° C.) showed four broad peaks which upon integration showed that the polymer contained 17.5 mole percent of 1,2,3,3,3-pentafluoropropylene.

The polymer did not dissolve in hexafluorobenzene at room temperature. 100 mg of the polymer were suspended in 4 mL hexafluorobenzene (4 mL) and heated to 60° C. a clear solution was not obtained even on prolonged (4 hours) stirring.

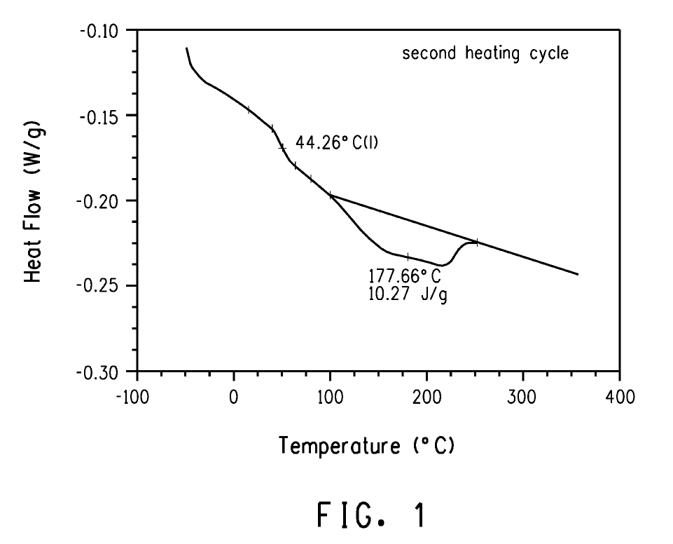

FIG. 1 shows the DSC results obtained according to the method described above. A well defined endotherm was identified corresponding to a melting transition at 177.66° C., and a heat of fusion of ca 10 J/g.

### Example 4

The materials and procedures of Example 1 were replicated except that the ratio of 1,2,3,3,3-pentafluoropropylene to TFE was slightly higher to give a polymer containing 30 mol-% of monomer units derived from 1,2,3,3,3-pentafluoropropylene.

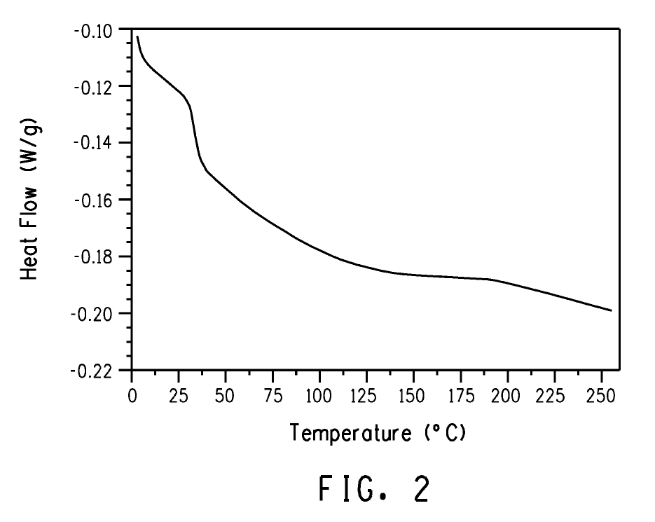

FIG. 2 shows the DSC results obtained. No melting endotherm could be discerned.

### Example 5

The materials and procedures of Example 1 were replicated except that the ratio of 1,2,3,3,3-pentafluoropropylene to TFE was slightly higher to give a polymer containing 40 mol-% of monomer units derived from 1,2,3,3,3-pentafluoropropylene.

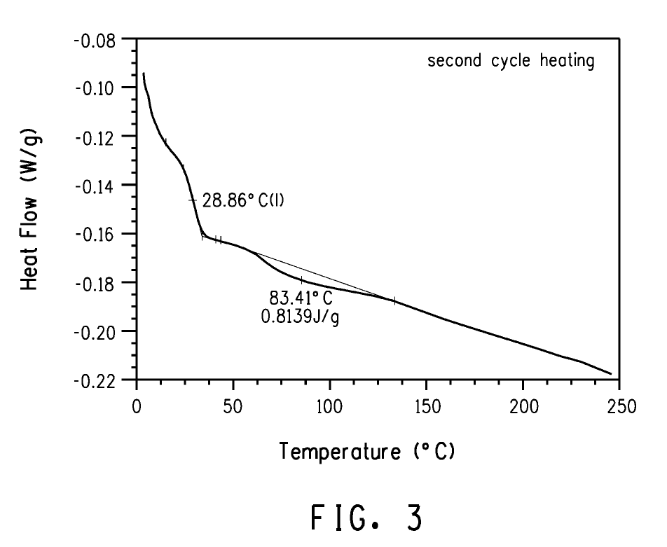

FIG. 3 shows the DSC results obtained. A very small melting endotherm associated with a crystalline melting point of 83° C. might be an artifact. The associated heat of fusion was 0.7 J/g.

What is claimed is:

1. A film comprising an amorphous copolymer comprising 50 to 80 mole percent of monomer units derived from tetrafluoroethylene and 20 to 50 mole percent of monomer units derived from 1,2,3,3,3-pentafluoropropylene.

2. The film of claim 1 wherein the copolymer comprises 25 to 50 mole percent of monomer units derived from 1,2,3,3,3-pentafluoropropylene.

3. The film of claim 2 wherein the copolymer comprises 25 to 45 mole percent of monomer units derived from 1,2,3,3,3-pentafluoropropylene.

4. The film of claim 1 wherein the copolymer further comprises up to 10 mole percent of one or more additional monomer units derived from olefinic monomers.

5. The film of claim 1 having a surface and a coating or layer of another polymer disposed on the surface.

6. The film of claim 1 as a free-standing film.

7. The film of claim 1 having a thickness of 10 to 250 micrometers.

8. The film of claim 7 wherein the thickness is in the range of 25-100 micrometers.

9. The film of claim 1 in the form of a pellicle.

10. A process comprising subjecting to heat and pressure a dry copolymer comprising 50 to 80 mole percent of monomer units derived from tetrafluoroethylene and 20 to 50 mole percent of monomer units derived from 1,2,3,3,3-pentafluoropropylene to form a film having two surfaces,

11. The process of claim 10 wherein the copolymer comprises 25 to 50 mole percent of monomer units derived from 1,2,3,3,3-pentafluoropropylene.

12. The process of claim 11 wherein the copolymer comprises 25 to 45 mole percent of monomer units derived from 1,2,3,3,3-pentafluoropropylene.

13. The process of claim 10 wherein the copolymer further comprises up to 10 mole percent of one or more additional monomer units derived from olefinic monomers.

14. The process of claim 10 further comprising contacting a surface of the film with a solution comprising a solvent and a second polymer, wherein the solvent is not a fluoroaromatic polymer and the second polymer is different in composition from the copolymer, to form a coating upon the surface, and evaporating the solvent to form a coated film.

15. The process of claim 10 wherein the film has a thickness in the range of 10 to 250 micrometers.

16. The process of claim 15 wherein the thickness is in the range of 25-100 micrometers.
